(19) United States
(12) Patent Application Publication
(10) Pub. No.: US 2025/0197178 A1
(43) Pub. Date: Jun. 19, 2025

(54) DRIVERLESS TRANSPORT DEVICE WITH ADJUSTABLE WIDTH FUNCTION

(71) Applicant: AGILOX SYSTEMS GMBH, Neukirchen bei Lambach (AT)

(72) Inventors: Meinhard Schwaiger, Linz (AT); Daniel Zindl, Marchtrenk (AT); Franz Humer, Pennewang (AT); Josef Baumann-Rott, Vöcklamarkt (AT)

(21) Appl. No.: 18/847,864

(22) PCT Filed: Mar. 7, 2023
(86) PCT No.: PCT/AT2023/060062

§ 371 Date: Sep. 17, 2024

(30) Foreign Application Priority Data
Mar. 18, 2022 (AT) A 50178/2022

(51) Int. Cl. B66F 9/06

(52) U.S. Cl. CPC B66F 9/063

(57) ABSTRACT

The invention relates to a driverless transport device for the automatic, space-saving and collision-free picking-up, transport, lifting and delivery of pallets closed at the bottom and pallets open at the bottom, wherein the wheel arms of the chassis, which is substantially U-shaped in plan view, can be displaced transversely together or independently of one another relative to the base unit or to the lower part of the base unit of the transport device and can be positioned in a first position in alignment below and in a second position laterally outwardly spaced from the lifting fork tines in the width of the transport device, wherein the lifting fork tines are movable with the lifting fork back independently of the wheel arms relative to the base unit or to the lower part of the base unit independently of the wheel arms, and the transport device can be moved omnidirectionally along any trajectories from any first point to any second point. In this way, pallets open at the bottom, the width of which is smaller than the width of the transport device, can be picked up or deposited flush, e.g. laterally on the inner walls of loading containers or other lateral boundary surfaces, without collision. The driverless transport device according to the invention is particularly light, requires no counterweight, has the lowest possible energy consumption and the lowest possible space requirement and requires no additional equipment.

The invention relates to a driverless transport device for the automatic, space-saving and collision-free pick-up, transport, lifting and delivery of pallets closed and open at the bottom, comprising a chassis that is essentially U-shaped in plan view with a base unit, two legs and a lifting device consisting of a vertical guide and a lifting carriage to which lifting forks are attached.

Pallets open at the bottom are those with recesses open at the bottom, which can also be driven under by a fork rolling on the floor. In the case of a pallet closed at the bottom, only closed recesses are available into which a lifting fork tine lifted off the floor can be inserted. In the following description, the term pallet always includes the goods stored on it.

According to the prior art, counterbalanced forklifts, such as those disclosed in US D597622S, US 2021/0395060 A1, DE 103 21 773 A1, have lifting forks that are rigidly or transversely adjustable on a lifting device, e.g. on a lifting mast, a chassis arranged opposite the lifting forks, whose own weight requires a multiple of the lifting load for stability reasons, causes high energy consumption and the drive system prevents unrestricted omnidirectional mobility along any trajectories, so that a maneuvering area in the order of a multiple of the pallet footprint is required.

Furthermore, DE 10 2021 115 805 A1, CN 113968554 A and EP 3 034 453 A1 disclose devices for translatory transverse movements for forklifts and similar self-propelled working machines with forks (lifting forks), which, when attached to an arm or to the lifting device, enable a transverse movement of lifting forks to a first direction of movement. The working machine disclosed as a counterbalanced forklift requires several times the lifting load in dead weight for stability reasons, has high energy consumption, and the maneuvering area is on the order of several times the pallet footprint.

DE 10 2016 123 326 A1 discloses a high-lift industrial truck with rigidly arranged wheel arms vertically aligned with forks with fixed fork spacing, which are vertically movable in a lift frame. The rigidly designed support wheels in the wheel arms prevent unrestricted omnidirectional movement along any trajectories, so that a maneuvering area in the order of a multiple of the pallet footprint is required and the wheel arms arranged in alignment below the forks prevent the pickup of pallets closed at the bottom.

CN 11347233 (A), CN 113493173 A, JP2021151857A, U.S. Pat. No. 10,988,155 B2, US 2022/0041417 A1 disclose low-lift industrial trucks whose wheel arms are adjustable transversely to the longitudinal axis of the wheel arm and are designed with support wheels or driven non-steerable wheels and are designed directly as load handling attachments or are connected in vertical alignment with vertically movable load handling attachments located above them. The rigidly designed support wheels or driven wheels in the wheel arms prevent unrestricted omnidirectional movement along any trajectories, so that a maneuvering area in the order of a multiple of the pallet footprint is required, and the wheel arms arranged in alignment below the forks prevent the pickup of pallets closed at the bottom.

EP 3 689 813 A1, EP 3 517 483 A1 disclose reach trucks with rigidly designed wheel arms and support wheels, wherein the wheel arms are laterally spaced from the load/the load handling attachment and the load part is movable relative to the wheel arms in the longitudinal direction. The wheel arms spaced laterally from the load prevent collision-free flush picking up or placement of pallets adjacent to boundary surfaces or other pallets, and the rigidly designed support wheels in the wheel arms prevent unrestricted omnidirectional mobility along any trajectories, so that a maneuvering area in the order of a multiple of the pallet footprint is required.

DE 10 2015 108 993 A1, DK/EP 3626676 T3 disclose broad-gauge stackers, having rigidly arranged wheel arms, having steerable and driven wheels in the wheel arm or non-driven support wheels in the wheel arm, having a solid load part between the wheel arms so that the load is located between the two wheel arms. The wheel arms, which are laterally spaced from the load, prevent collision-free flush pickup or placement of pallets adjacent to boundary surfaces or other pallets.

EP 2 336 075 A1 discloses a driverless transport system for automatically picking up, transporting and delivering pallets, wherein the transport system is designed with a U-shaped chassis, omnidirectional drives and lifting forks located in alignment on the U-shaped chassis so that only pallets open at the bottom can be manipulated.

WO2021/223351 A1 discloses a loading and unloading system for goods containers consisting of a first and a second vehicle system, wherein the first vehicle system is a classic forklift truck which, due to its large size, cannot drive into the interior of the goods container, and the second vehicle system is a non-steerable shuttle vehicle with which the load can be brought into and out of the goods container along straight travel paths. The high dead weight of the first vehicle system, which requires a multiple of the lifting load for stability reasons, causes high energy consumption, and the drive system of the first and second vehicle systems prevent unrestricted omnidirectional movement along any trajectories, so that a maneuvering area in the order of a multiple of the pallet footprint is required.

DE 10 2015 100 815 A1 discloses a truck-mounted forklift consisting of a frame with drive section and lifting frame and a chassis section with two parallel spaced wheel arms with load wheels, wherein the two wheel arms are connected to the drive section by means of a torsionally rigid non-circular guide, one wheel arm on the left and one wheel arm on the right inserted from the side in the frame, in such a way that the wheel arms can be adjusted laterally in the transverse axis of the truck in a stepless or rasterized manner, wherein the smallest clear width of the wheel arms corresponds to the width of the drive section with lifting frame.

Driverless lifting and transport devices known from the prior art are not available in particular for the collision-free and automated handling of pallets open or closed at the bottom in confined spaces, for the automated pick-up, transport and delivery of such pallets flush e.g. laterally with the inner walls of loading containers or other lateral boundary surfaces, the unrestricted omnidirectional movement of the transport device with or without load along any trajectory from any first point to any second point, i.e. forwards, backwards at any angle to a first direction of movement sideways, in a straight line or diagonally, and around any vanishing point, i.e. also turning at a standstill, with only a single lifting and transport device, with the lowest possible energy consumption and the lowest possible space requirement without additional auxiliary devices.

The invention is based on the task to represent a manipulation of both bottom-closed and bottom-open pallets with the smallest possible space requirement and to enable collision-free operation even during transport on narrow traffic areas.

This object is solved by a driverless transport system in which the two legs of the U-shaped chassis are designed as transversely adjustable wheel arms which, in a first position, can be positioned in alignment below the lifting fork tines and, in a second position, can be positioned laterally outwardly spaced from the lifting fork tines in the width of the transport device.

This means that wheel units are attached to the forward-projecting legs of the chassis, via which part of the weight of the lifted load can be supported. This is why these legs are also referred to as wheel arms.

An essential feature of the invention is that pallets open at the bottom can be completely driven under, i.e., practically no space to walls or other stored goods is required laterally to receive or deposit the pallet.

In the case of pallets closed at the bottom, a corresponding clearance is required for the laterally moving wheel arms. However, as soon as the pallet is lifted, the wheel arms can be moved under the pallet so that the width of the transport device no longer exceeds that of the pallet. This means that transport is possible even on very narrow transport routes.

The advantages of the invention are thus particularly beneficial where bottom-open and bottom-closed pallets are used in mixed applications.

Preferably, it is provided that the wheel arms are transversely displaceable together or independently of each other relative to the base unit or the lower part of the base unit of the transport device. In particular, an independent possibility of adjustment offers the advantage of optimally utilizing the available space.

A first preferred embodiment variant of the invention provides that the lifting fork tines are firmly connected to a rear wall. This means that the lifting fork unit is rigid and can be designed with particularly robust rigidity.

Flexibility in the use of the transport device can be increased in that the rear wall can be moved transversely relative to the base unit or the lower part of the base unit. Thus, if it is not possible to position the transport device optimally in front of a pallet for reasons of space, so that a collision of the lifting fork tines with the pallet is to be feared, then an improvement can be achieved by shifting the lifting fork unit.

An alternative embodiment variant provides for the lifting fork tines to be transversely displaceable independently of each other. This also allows the distance between the lifting forks to be changed depending on the situation.

Preferably, the wheel arms each have a steerable wheel unit, i.e., active steerability is provided. These wheel units can have driven or non-driven wheels. In the case of driven wheels, it is preferred if two wheels can be driven independently of each other, so that the steering movement can be performed by the wheel drive. Otherwise, a motor may be provided for steering. In this context, it is particularly advantageous if the base unit has at least one, preferably at least two, steerable drive unit(s). This allows the transport device to be moved omnidirectionally along any trajectories from any first point to any second point, i.e. it is movable over an area.

Ground unevenness can be compensated particularly well if the steerable drive unit is mounted so that it can rotate about a vertical axis and tilt about a horizontal axis.

Furthermore, it is preferred if the vertical guide of the lifting device is a simple lifting mast or a telescopic guide device and the lifting drive of the lifting device is, for example, electric, hydraulic or pneumatic and the lifting movement is transmitted by means of a chain drive, a belt drive, a threaded spindle drive or a cylinder.

A particularly maneuverable and space-saving design of the transport device according to the invention can be achieved if the wheel arms are transversely displaceable beyond the width of the base unit. In this way, the transport device can be made so narrow that it normally does not project laterally beyond a pallet, except in the state in which the wheel arms are extended laterally in order to pick up or set down a pallet closed at the bottom.

The present invention also relates to a method for manipulating pallets, in which a driverless transport device optionally moves in under a pallet open at the bottom with two legs of a U-shaped chassis together with lifting fork tines arranged thereon, lifts the lifting fork tines and moves the pallet open at the bottom, or moves the legs of the U-shaped chassis laterally outward, moves them to the side of a pallet, with the lifting fork tines engaging under the pallet, and then lifts the lifting fork tines and moves the pallet.

Preferably, the legs of the U-shaped chassis are moved laterally inwards under the pallet when it is raised.

In addition, it is also possible that the lifting forks are displaced laterally.

The invention is explained in more detail below with reference to the non-limiting exemplary embodiment with the accompanying figures, wherein:

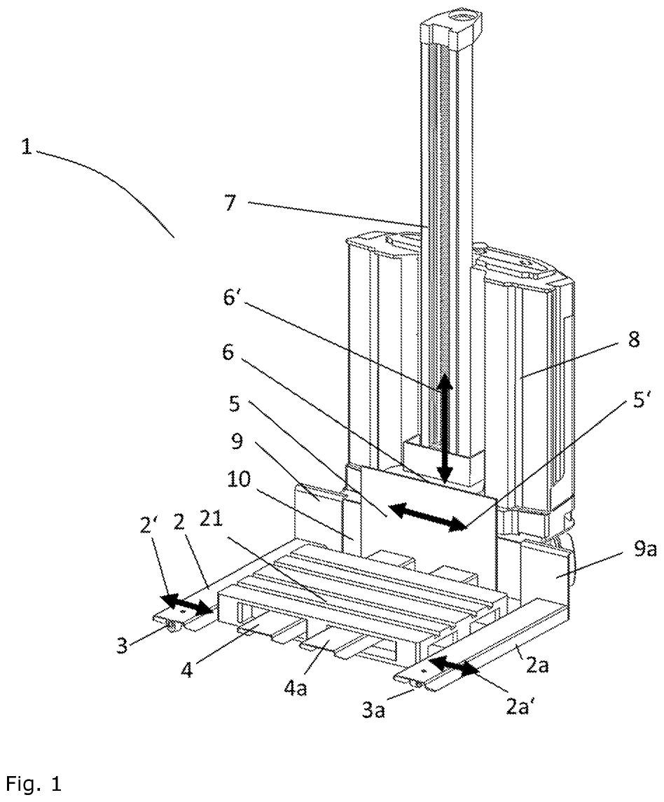

FIG. 1 shows a driverless transport device according to the invention in oblique view from above with a pallet closed at the bottom on the lifting forks and the wheel arms in a position laterally spaced outwards from the pallet;

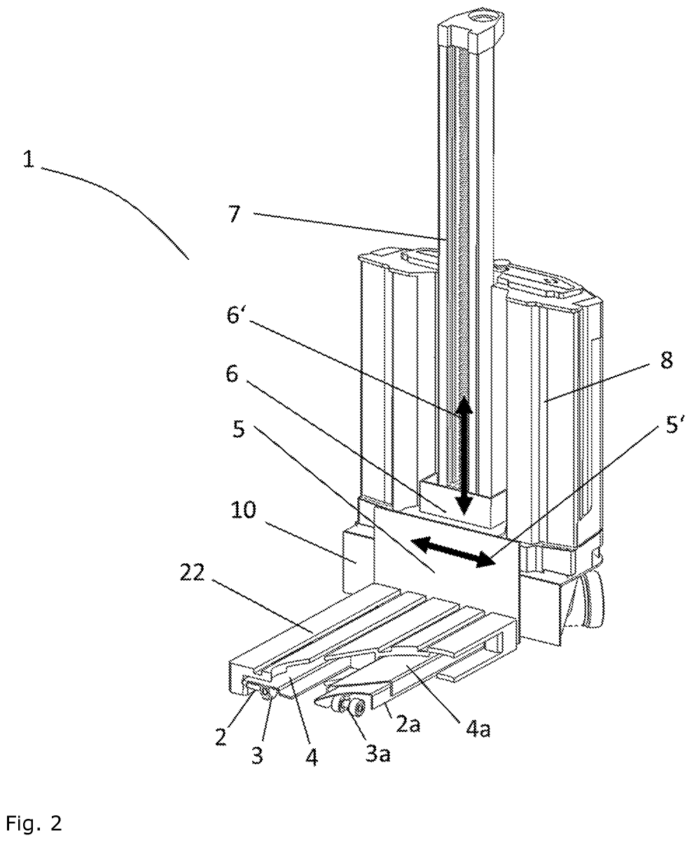

FIG. 2 shows the driverless transport device according to the invention in oblique view from above with a pallet open at the bottom on the lifting fork tines and the wheel arms in vertical alignment with the lifting fork tines and position of the lifting fork centrally to the base unit of the transport device;

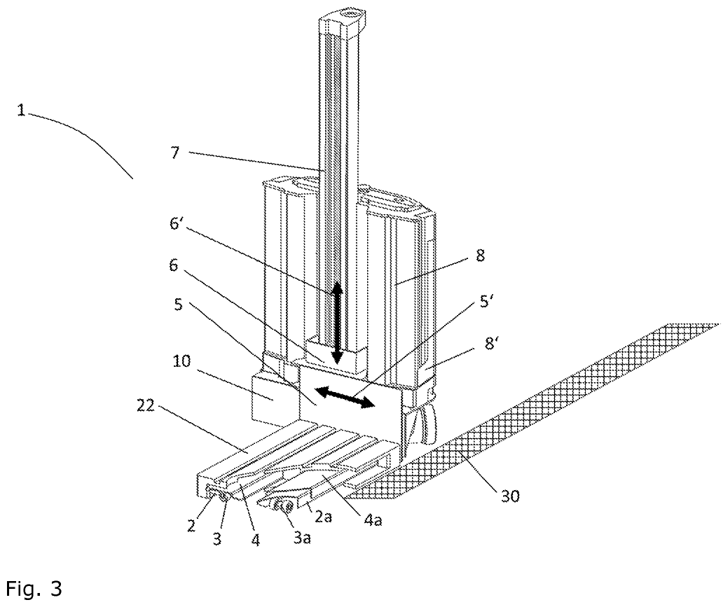

FIG. 3 shows the driverless transport device according to the invention in oblique view from above with a pallet open at the bottom on the lifting fork tines and the wheel arms in position vertically aligned to the lifting fork tines and position of the lifting fork displaced in transverse direction to the base unit of the transport device for approximately flush alignment of the pallet with respect to the lateral width limitation of the base unit of the transport device for collision-free pick-up or delivery of the pallet at a lateral limiting surface;

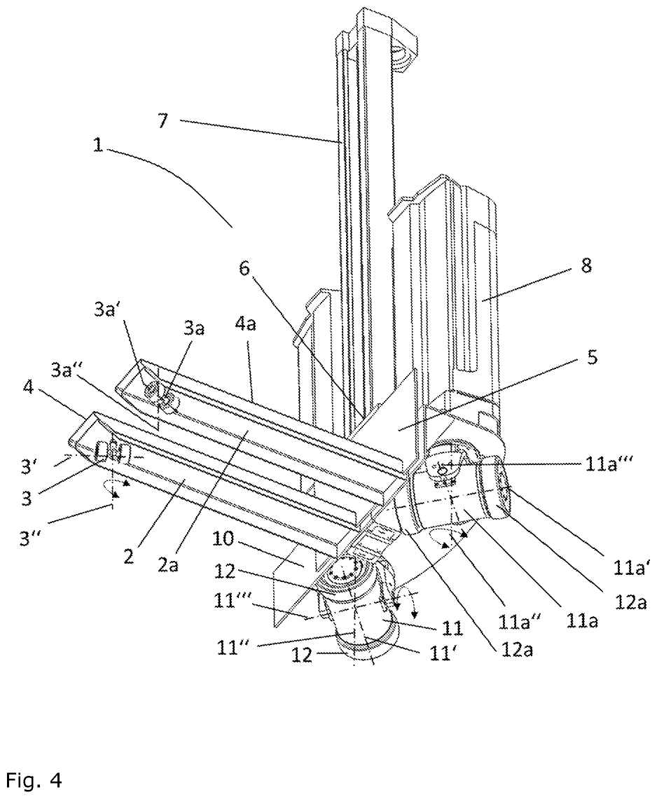

FIG. 4 shows the driverless transport device according to the invention in oblique view from below with the wheel arms in vertical aligned position with the lifting fork tines and position of the lifting fork displaced in transverse direction with respect to the base unit of the transport device for approximately flush alignment of the pallet with respect to the lateral width limitation of the base unit of the transport device;

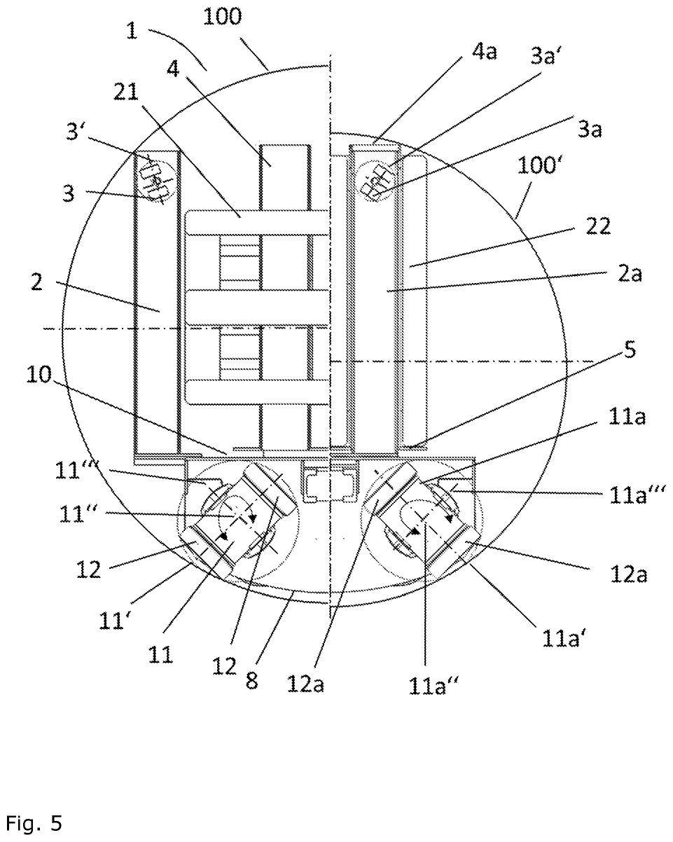

FIG. 5 shows the driverless transport device according to the invention as seen from below with a pallet closed at the bottom in the left half representation and a pallet open at the bottom in the right half representation with the smallest possible turning circles with the furthest spaced wheel arms (left half representation) and the smallest spaced wheel arms (right half representation).

The driverless transport device 1 according to the invention is used for automatic, space-saving and collision-free picking up, lifting and for transporting, lifting and delivering pallets 2 which are closed at the bottom and open at the bottom, wherein the transport is the movement of the pallet from any first point to any second point along unrestricted trajectories without additional devices. The driverless transport device 1 according to the invention has a substantially U-shaped chassis having two legs, wherein the legs are formed as wheel arms 2, 2a, which are transversely displaceable together or independently of each other relative to the base unit 8 or to the lower part of the base unit 10 of the transport device 1 in the direction 2′, 2a′ and are positionable in a first position aligned below and in a second position laterally in the direction 2′, 2a′ outwardly spaced from the lifting fork tines 4, 4a. Actively or passively steerable driven or non-driven wheels 3, 3a are located on the wheel arms 2, 2a in the front region, and the wheel arms 2, 2a are each connected at their rear end to a rear wall 9, 9a and are mounted therewith so as to be transversely displaceable relative to the base unit 8 or to the lower part of the base unit 10 and are displaceable in the direction 2′, 2a′ by means of an electrically, pneumatically, hydraulically or otherwise actuated drive system not shown in greater detail. The lifting fork tines 4, 4a are connected to a rear wall 5 and form the lifting fork, which is displaceable as a whole in the direction 5′ transversely to the base unit 8 or to the lower part of the base unit 10. In another particularly preferred embodiment variant, the lifting fork tines 4, 4a can be designed to be displaceable independently of one another relative to the rear wall 5 in the direction 5′ transversely to the rear wall 5 or to the base unit 8 or to the lower part of the base unit 10. By means of a lifting device, for example consisting of a lifting carriage 6 and a vertical guide 7, the lifting fork can be moved vertically in the direction 6′. The vertical guide 7 can be a simple lifting mast or a telescopic guide device, the lifting drive of the lifting device, which is not shown in greater detail, can be, not restrictively, electric, hydraulic or pneumatic and the transmission of the lifting movement can be, also not restrictively, by means of a chain drive, a belt drive, a threaded spindle drive or a cylinder. The base unit 8 includes the control system, communication, power supply, optical and acoustic signal elements, safety devices, cameras, protective coverings and the like. The lower part of the base unit 10 is rigidly connected to the base unit 8 and the vertical guide 7, and to the transversely displaceable rear walls 9, 9a of the wheel arms 2, 2a. The drive system consists of at least one steerable drive unit 11 or 11a, which is pivotably mounted about the vertical axis 11″ or 11a″ and, in a particularly preferred embodiment, is also mounted so as to be horizontally tiltable about the horizontal axis 11′″ or 11a′″, and has at least one drive wheel 12 or 12a rotatable about the axis of rotation 11′ or 11a′, preferably each drive unit 11 or 11a is designed with two drive wheels 12 or 12a, the speed and direction of rotation of which can be changed independently of one another, so that by means of at least one of the drive units 11, 11a and/or the wheels 3, 3a, which can be rotated about the horizontal axis 3′, 3a′ and can be pivoted about the vertical axis 3″, 3a″, the transport device can be moved along any desired trajectories. The driverless transport device 1 according to the invention is designed to be of particularly compact design, so that only a small turning circle is produced for turning at a standstill, the diameter of the turning circle 100 of which, with the wheel arms 2, 2a spaced furthest outwards and a pallet 21 closed at the bottom as the transport material, is only approx. 60% larger than the diagonal of a standard pallet, and with the smallest distance between wheel arms 2, 2a and an open-bottom pallet 22 as the goods to be transported, the diameter of the turning circle 100′ is only about 40% larger than the diagonal of a standard pallet.

The arrangement of the drive units 11, 11a directly underneath the base unit 8 and the arrangement of the wheels 3, 3a in the front end areas of the wheel arms 2, 2a has the effect that the center of gravity of the transport device according to the invention is always located within the area spanned by the drive units 11, 11a and the wheels 3, 3a in the unloaded and in the loaded state in conformity with the standard, e.g. according to ISO 8611, so that a permanent tilt-stable state is provided and a counterweight is not required for stabilization, so that a very low dead weight, which is smaller than the maximum intended payload, a low energy consumption and a low floor load are achieved.

Sensors, e.g. for safety monitoring, obstacle detection, person detection, detection of the orientation of pallets and the environment, are provided in the lifting forks 4, 4a, the wheel arms 2, 2a and the base unit 8, among others.

The unrestricted maneuverability and the lateral adjustability of the lifting forks 4, 4a and the wheel arms 2, 2a in such a way that the transport pallet 22 is aligned at least with the largest lateral width 8′ of the base unit 8 or of the lower part of the base unit 10 enable the pallet 22 to be picked up or delivered almost flush with boundary surfaces 30, such as, for example, the inner walls of loading containers, or other lateral boundary surfaces.

By selectively controlling the drive unit 11, 11a, the transport device can travel omnidirectionally from any first point to any second point along any trajectories, including bending trajectories with turning at a standstill, without any restrictions.

Open-bottom pallets 22 whose width is smaller than the width of the transport device 1 can be picked up or deposited flush, e.g. laterally on the inner walls of loading containers or other lateral boundary surfaces 30 without collision.

Sensors, for example, for safety monitoring, obstacle detection, detection of the orientation of pallets and the environment are integrated in the lifting forks 4, 4a, in the wheel arms 2, 2a and or in the base unit 8.

The transport device 1 has a base unit 8, which has at least one of the group of elements listed below in a non-limiting manner, such as, for example, a control system, devices for communication, the power supply, optical and/or acoustic signal elements, safety devices, a protective covering, a camera and the like.

The transport device 1 is designed to be compact and particularly light without counterweight and has a particularly small surface area requirement, wherein the smallest possible turning circle 100 when turning at a standstill is only approx. 60% larger than the diagonal of a standard pallet when the wheel arms 2, 2a are spaced furthest outwards and a bottom-closed pallet 21 is used as the transport material, and when the wheel arms 2, 2a are spaced at the smallest distance and a bottom-open pallet 22 is used as the transport material, the diameter of the turning circle 100′ is only approx. 40% larger than the diagonal of a standard pallet.

The driverless transport device according to the invention is particularly light, requires no counterweight, has the lowest possible energy consumption as well as the lowest possible space requirement and requires no additional equipment.

### LIST OF REFERENCE SIGNS

1 Driverless transport device according to the invention
2, 2a Wheel arm
2′, 2a′ Transverse displacement direction of the wheel arms
3, 3a Wheels in wheel arm
3′, 3a′ Rotation axis of the wheels
3″, 3a″ Vertical pivot axis of the wheels
4, 4a Lifting fork tines
5 Rear wall of the lifting fork tines
5′ Transverse displacement direction of the lifting fork
6 Lifting carriage
6′ Lifting direction of the lifting carriage
7 Vertical guide
8 Base unit
8′ Largest width 8′ of the base unit or of the lower part of the base unit
9, 9a Rear end of the wheel arms
10 Lower part of the base unit
11, 11a Steerable drive unit
11′, 11a′ Rotation axis of drive wheel 12, 12a
11″, 11a″ Vertical pivot axis of the drive unit
11′″, 11a′″ Horizontal tilting axis of the drive unit
12, 12a Drive wheel
13, 13a Wheel unit
21 Pallet closed at the bottom
22 Pallet open at the bottom
30 Lateral boundary surface (e.g. inner wall of container)
100, 100′ Turning circle when turning at a standstill with the wheel arms spaced furthest outward and the wheel arms spaced smallest, respectively

1. A driverless transport device for the automatic, space-saving and collision-free picking-up, transport, lifting and delivery of pallets closed at the bottom and pallets open at the bottom, comprising: a chassis which is U-shaped in plan view and having a base unit, two legs and a lifting device, consisting of a vertical guide and a lifting carriage, on which lifting fork tines are mounted, wherein the two legs of the U-shaped chassis are designed as transversely adjustable wheel arms which, in a first position, can be positioned in alignment below the lifting fork tines and, in a second position, can be positioned laterally in the width of the transport device at a distance outwards from the lifting fork tines.

2. The transport device according to claim 1, wherein the wheel arms are transversely displaceable together or independently of each other relative to the base unit or to the lower part of the base unit of the transport device.

3. The transport device according to claim 1, wherein the lifting fork tines are firmly connected to a rear wall.

4. The transport device according to claim 3, wherein the rear wall is transversely displaceable relative to the base unit or to the lower part of the base unit.

5. The transport device according to claim 1, wherein the lifting fork tines are transversely displaceable independently of one another.

6. The transport device according to claim 1, wherein the wheel arms each have a steerable wheel unit.

7. The transport device according to claim 1, wherein the base unit comprises at least one, preferably at least two, steerable drive unit.

8. The transport device according to claim 7, wherein the steerable drive unit is mounted rotatably about a vertical axis and tiltably about a horizontal axis.

9. The transport device according to claim 7, wherein the steerable drive unit comprises two independently driven drive wheels.

10. The transport device according to claim 1, wherein the vertical guide of the lifting device is a lifting mast or a telescopic guide device and the lifting drive of the lifting device is effected, for example, electrically, hydraulically or pneumatically and the transmission of the lifting movement is effected by means of a chain drive, a belt drive, a threaded spindle drive or a cylinder.

11. The transport device according to claim 1, wherein the wheel arms are transversely displaceable beyond the width of the base unit.

12. A method for manipulating pallets, in which a driverless transport device optionally moves in under a pallet open at the bottom with two legs of a U-shaped chassis together with lifting fork tines arranged thereon, raises the lifting fork tines and moves the pallet that is open at the bottom, or displaces the legs of the U-shaped chassis laterally outward, moves them to the side of a pallet, with the lifting fork tines engaging under the pallet (21, 22), and then lifts the lifting fork tines and moves the pallet.

13. The method according to claim 12, wherein characterised in that the legs of the U-shaped chassis are displaced laterally inwards under the pallet when the pallet is raised.

14. The method according to claim 12, wherein the lifting fork tines are displaced laterally.
